(19) United States
(12) Patent Application Publication
(10) Pub. No.: US 2008/0136063 A1
(43) Pub. Date: Jun. 12, 2008

(54) Nanofiber and method for fabricating the same

(76) Inventors: Chung-Yang Chuang, Taipei City (TW); Shu-Hui Cheng, Hsinchu County (TW); Lien Tai Chen, Taoyuan County (TW)

Correspondence Address: BIRCH STEWART KOLASCH & BIRCH, PO BOX 747, FALLS CHURCH, VA, 22040-0747, US

(21) Appl. No.: 12/010,837

(22) Filed: Jan. 30, 2008

Related U.S. Application Data
(62) Division of application No. 11/221,898, filed on Sep. 9, 2005.

(30) Foreign Application Priority Data
Jul. 11, 2005 (TW) 94123341

(51) Int. Cl. B29C 47/00

(52) U.S. Cl. 264/464

(57) ABSTRACT

A nanofiber and fabrication methods thereof. The method for fabricating the nanofiber includes preparing an electrospinning composition and performing an electrospinning process employing the electrospinning composition. Particularly, the electrospinning composition includes a polymer and an additive as a uniform solution in an organic solvent, wherein the additive renders the electronic characteristic of the polymer.

This application is a Divisional of co-pending application Ser. No. 11/221,898 filed on Sep. 9, 2005, which claims priority on Taiwan Application No. 94123341 filed Jul. 11, 2005. The entire contents of each of these applications is hereby incorporated by reference.

### BACKGROUND

The present invention relates to a method for nanofiber fabrication, and more particularly to a method for fabricating nanofibers with controllable diameter.

Nanofibers are fibers having diameter less than 1 micrometer and have been developed for use in a wide range of applications such as high performance filters, drug delivery, scaffolds for tissue engineering, optical, and electronic applications, due to the advantages of increased specific surface area, extremely thin diameter, and super light weight.

In manufacture of nanofibers, the electrospinning process provides advantages of high productivity and continuous production, making it an industry choice. The nanofibers fabricated by conventional electrospinning, however, present a wide variation in configuration and diameter and have an average diameter not less than 800 nm. In other conventional electrospinning processes, lower feed rate or lower concentration of polymer solution, and larger distance between the nozzle and the receiving plate are suggested to decrease the average diameter of obtained nanofibers. The aforementioned electrospinning processes, however, fail to yield sufficient quantities of nanofibers.

As well, since the rheological properties and intramolecular interaction of polymer solutions depend on the characteristics and structure of the polymer molecules thereof, the variety of polymers applied to the conventional electrospinning processes is limited.

Accordingly, it is desirable to develop a novel electrospinning process, in which the variety of polymer sources is unlimited, to provide nanofibers of uniform configuration with reduced average diameter, further enabling mass production for common use.

### SUMMARY

Embodiments of the invention provide a nanofiber comprising the products of electrospinning composition subjected to an electrospinning process, wherein the electrospinning composition comprises a polymer and an additive as a uniform solution in an organic solvent, and the additive renders the electronic characteristic of the polymer solution. Particularly, the embodiments provide nanofibers with an average diameter of 15˜500 nm, preferably 15˜250 nm, wherein no decrease of dope feeding rate or no decrease concentration of electrospinning composition is required in the process.

Embodiments of the invention further provide a method for fabricating nanofiber. An electrospinning composition is provided and subjected to an electrospinning process, wherein the electrospinning composition comprises a polymer and an additive as a uniform solution in an organic solvent, and the additive renders the unique electronic characteristic of the polymer.

A detailed description is given in the following with reference to the accompanying drawing.

### BRIEF DESCRIPTION OF THE DRAWINGS

The invention can be more fully understood by reading the subsequent detailed description in conjunction with the examples and references made to the accompanying drawings, wherein:

FIG. 1 is a SEM (scanning electron microscope) photograph of the polyvinyl alcohol nanofiber according to Comparative Example 1.

FIGS. 2˜6 are SEM (scanning electron microscope) photographs of the polyvinyl alcohol nanofiber according to Examples 1˜5.

FIG. 7 is a SEM (scanning electron microscope) photograph of the polystyrene nanofiber according to Comparative Example 2.

FIGS. 8˜10 are SEM (scanning electron microscope) photographs of the polystyrene nanofiber according to Examples 6˜8.

FIG. 11 is a SEM (scanning electron microscope) photograph of the polycarbonate nanofiber according to Comparative Example 3.

FIGS. 12˜15 are SEM (scanning electron microscope) photographs of the polycarbonate nanofiber according to Examples 9˜12.

FIG. 16 is a SEM (scanning electron microscope) photograph of the polyvinylidene fluoride nanofiber according to Comparative Example 4.

FIGS. 17˜19 are SEM (scanning electron microscope) photographs of the polyvinylidene fluoride nanofiber according to Examples 13˜15.

FIG. 20 is a SEM (scanning electron microscope) photograph of the polyvinylidene fluoride hexafluoropropylene nanofiber according to Comparative Example 5.

FIGS. 21˜22 are SEM (scanning electron microscope) photographs of the polyvinylidene fluoride hexafluoropropylene nanofiber according to Examples 16˜17.

FIG. 23 is a SEM (scanning electron microscope) photograph of the polyvinylidene fluoride hexafluoropropylene nanofiber according to Comparative Example 6.

FIGS. 24˜26 are SEM (scanning electron microscope) photographs of the polyvinylidene fluoride hexafluoropropylene nanofiber according to Examples 18˜20.

### DETAILED DESCRIPTION

According to embodiments of the invention, the electrospinning composition comprises a polymer and an additive as a uniform solution in water or an organic solvent. As a main feature and a key aspect, the additive used in embodiments of the invention is selected to render the electronic characteristic of the polymer solution.

In embodiments of the invention, the polymer can comprise water-soluble polymer, solvent-soluble polymer, biopolymer or combinations thereof, such as polyethylene, polyvinyl alcohol, sodium alginate, gelatin, collagen, polystyrene, polycarbonate, chitosan, fluorine polymer, polyester, polyamide, or polyimide.

In embodiments of the invention, the additive can comprise organic or inorganic salt, organic or inorganic acid, organic or inorganic base, polar compound, oligomer (C₁₋₁₈) or combinations thereof. Particularly, the additive is an electrolyte comprising organic or inorganic salts. Preferably, the organic or inorganic salt can comprise fluorine salt, chlorine salt, bromine salt, iodine salt, sulfate salt, nitrate salt, carboxylate salt, oxalate salt, borate salt, sulfonate salt, perchlorate salt, citrate salt, lithium salt, sodium salt, potassium salt, beryllium salt, calcium salt, aluminum salt, magnesium salt, titanium salt, or combinations thereof. Preferably, the organic acid, inorganic acid, organic base, or inorganic base can be monoacid, polyacid, monobase, or polybase, comprising C₁₋₁₈ carboxylic acid, C₁₋₁₈ alcohol, ammonia, imidazole, metal hydroxyl compound, hydrochloric acid, nitric acid, boric acid, perchloric acid, sulfuric acid, phosphoric acid, lactic acid, benzoic acid, or citric acid. Preferably, the polar compound can comprise pyridine, formamide, dimethylformamide, N-dimethylacetamide, N-methylpyrrolidone, valerolactam, caprolactam, o-dichlorobenzene, tetramethylurea, acetonitrile, or combinations thereof, more preferably pyridine. It should be noted that the additive is present in an amount of 0.01 wt % to 15 wt % of the electrospinning composition, preferably 0.05 wt % to 12 wt %, more preferably 0.1 wt % to 10 wt %.

The electrospinning composition is loaded into a spinneret to perform an electrospinning process. Since the additive enhances the electronic characteristic of the polymer solution, the average diameter of obtained nanofiber can be reduced to 15˜500 nm without decreasing the feed rate or the concentration of electrospinning composition, or increasing the distance between nozzle and receiving plate of the spinneret. The electrospinning process can have an applied voltage of 20˜50 KV and employ a spinneret with a distance from a needle tip to a receiving plate of 10˜30 cm, preferably less than 20 cm. Moreover, in embodiments of the invention, the feed rate of electrospinning composition in the electrospinning process can be more than 10 μl/min per nozzle.

The following examples are intended to demonstrate the invention more fully without limiting its scope, since numerous modifications and variations will be apparent to those skilled in the art.

### COMPARATIVE EXAMPLE 1

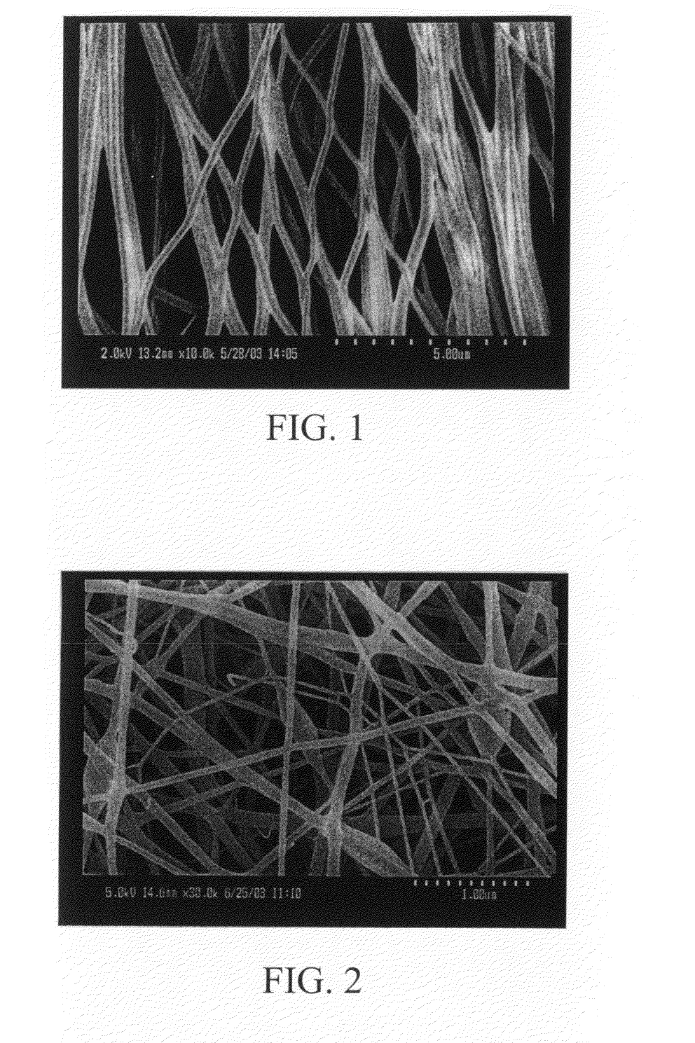

Polyvinyl alcohol powder (molecular weight: 88000 g/mol and chemical purity >99.5%) was dissolved in water at 80° C. to prepare a solution with 10 wt % polyvinyl alcohol. After cooling to room temperature, the polyvinyl alcohol solution was loaded into a spinneret. The applied voltage of the electrospinning process was 40 KV, the diameter of the nozzle 0.4 mm, the distance between the nozzle to the receiving plate 20 cm, and the feed rate of the polyvinyl alcohol solution 15 μl/min. The deposit was cut and polyvinyl alcohol nanofiber obtained at the receiving plate. The polyvinyl alcohol nanofiber was identified by scanning electron microscopy (SEM) as shown in FIG. 1. The average diameter thereof was then further measured, and the result is shown in Table 1.

### EXAMPLE 1

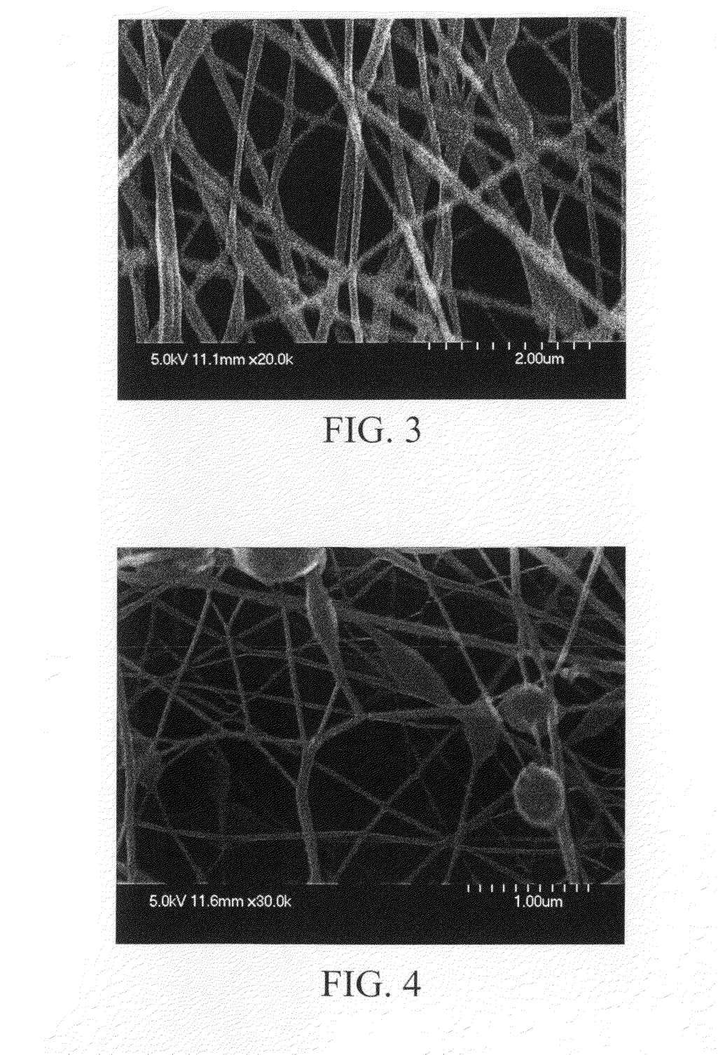

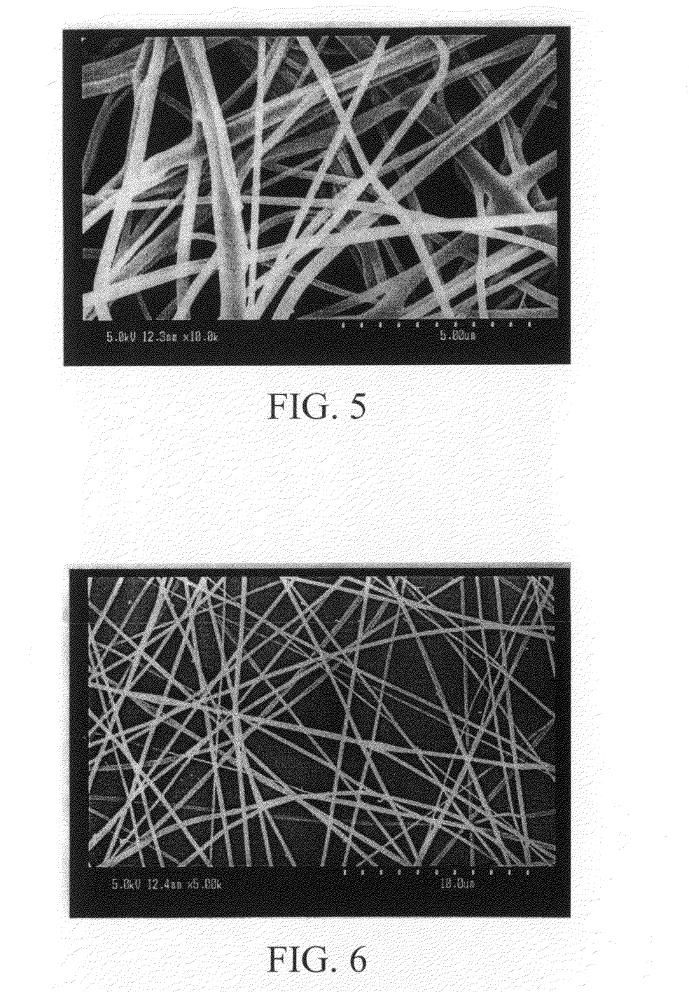

Polyvinyl alcohol powder (molecular weight: 88000 g/mol and chemical purity >99.5%) was dissolved in water at 80° C. to prepare a solution with 10 wt % polyvinyl alcohol. After cooling to room temperature, acetic acid was added into the above solution to prepare an electrospinning composition, wherein the acetic acid was present in an amount of 5 wt % of the electrospinning composition. After mixing completely, the electrospinning composition was loaded into a spinneret. Particularly, the applied voltage of the electrospinning process was 40 KV, the diameter of the nozzle 0.4 mm, the distance between the nozzle to the receiving plate 20 cm, and the feed rate of the electrospinning composition 15 μl/min. The deposit was cut and polyvinyl alcohol nanofiber obtained at the receiving plate. The polyvinyl alcohol nanofiber was identified by scanning electron microscopy (SEM) as shown in FIG. 2. The average diameter thereof was then further measured, and the result is shown in Table 1.

### EXAMPLE 2

Example 2 was performed the same as Example 1 with the exception of substitution of 5 wt % acetic acid with 10 wt % acrylic acid to prepare the electrospinning composition. The obtained polyvinyl alcohol nanofiber was identified by scanning electron microscopy (SEM) as shown in FIG. 3. The average diameter thereof was then further measured, and the result is shown in Table 1.

### EXAMPLE 3

Example 3 was performed the same as Example 1 with the exception of substitution of 5 wt % acetic acid with 2.4 wt % adipic acid to prepare the electrospinning composition. The obtained polyvinyl alcohol nanofiber was identified by scanning electron microscopy (SEM) as shown in FIG. 4. The average diameter thereof was then further measured, and the result is shown in Table 1.

### EXAMPLE 4

Example 4 was performed the same as Example 1 with the exception of substitution of 5 wt % acetic acid with 5 wt % ethanol to prepare the electrospinning composition. The obtained polyvinyl alcohol nanofiber was identified by scanning electron microscopy (SEM) as shown in FIG. 5. The average diameter thereof was then further measured, and the result is shown in Table 1.

### EXAMPLE 5

Example 5 was performed the same as Example 1 with the exception of substitution of 5 wt % acetic acid with 0.5 wt % water-soluble titania to prepare the electrospinning composition. The obtained polyvinyl alcohol nanofiber was identified by scanning electron microscopy (SEM) as shown in FIG. 6. The average diameter thereof was then further measured, and the result is shown in Table 1.

TABLE 1
average diameter of polyvinyl alcohol nanofiber

| | Average diameter | |
|---|---|---|
| Conventional wet | >30 | μm |
| spinning | | |
| Comparative Example 1 | 270 | nm |
| Example 1 | 50 | nm |
| Example 2 | 68 | nm |
| Example 3 | 51 | nm |
| Example 4 | 150 | nm |
| Example 5 | 186 | nm |

### COMPARATIVE EXAMPLE 2

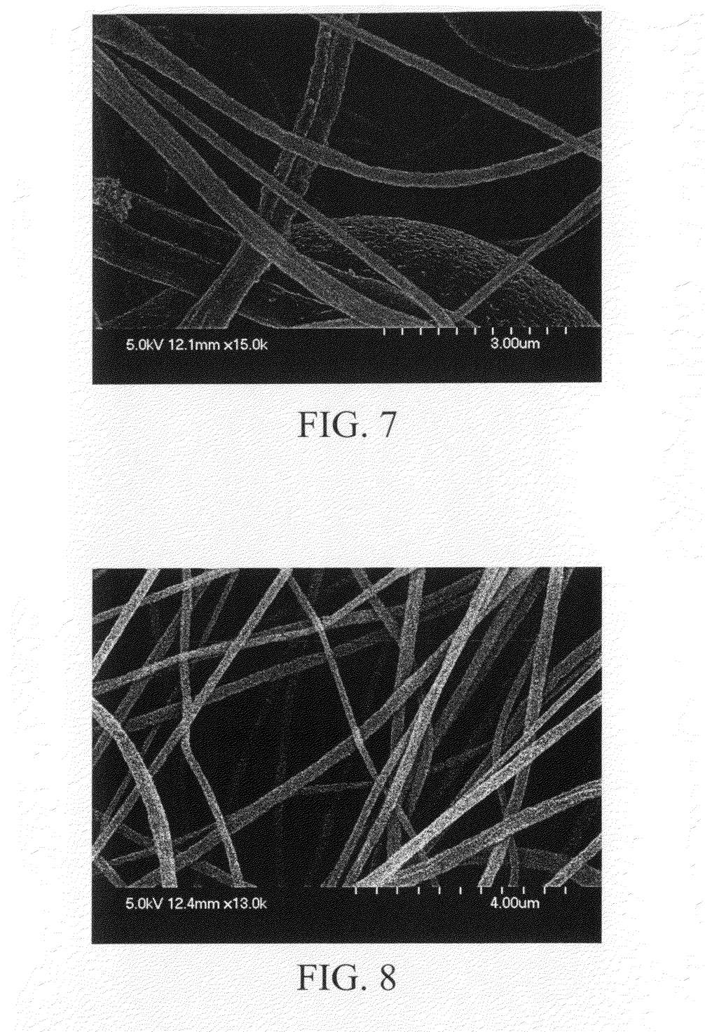

Polystyrene pellet (molecular weight: 170000 g/mol) was dissolved in dimethylacetamide to prepare a solution with 10 wt % polystyrene. The polystyrene solution was loaded into a spinneret. The applied voltage of the electrospinning process was 40 KV, the diameter of the nozzle 0.4 mm, the distance between the nozzle to the receiving plate 20 cm, and the feed rate of the polystyrene solution 15 μl/min. The deposit was cut and polystyrene nanofibers obtained at the receiving plate. The polystyrene nanofiber was identified by scanning electron microscopy (SEM) as shown in FIG. 7. The average diameter thereof was then further measured, and the result is shown in Table 2.

### EXAMPLE 6

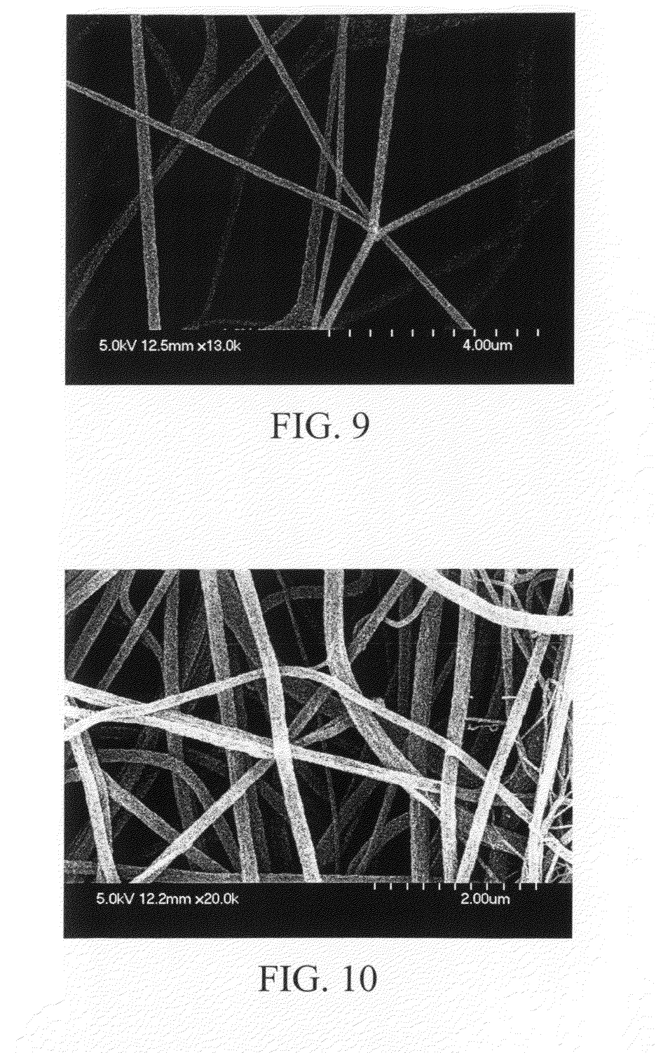

Polystyrene pellet (molecular weight: 170000 g/mol) was dissolved in dimethylacetamide to prepare a solution with 10 wt % polystyrene. Acetic acid was added into the above solution to prepare an electrospinning composition, wherein the acetic acid was present in an amount of 0.14 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the feed rate of the electrospinning composition 15 μl/min. The deposit was cut and polystyrene nanofiber obtained at the receiving plate. The polystyrene nanofiber was identified by scanning electron microscopy (SEM) as shown in FIG. 8. The average diameter thereof was then further measured, and the result is shown in Table 2.

### EXAMPLE 7

Example 7 was performed the same as Example 6 with the exception of substitution of 0.14 wt % acetic acid with 0.2 wt % pyridine to prepare the electrospinning composition. The obtained polystyrene nanofiber was identified by scanning electron microscopy (SEM) as shown in FIG. 9. The average diameter thereof was then further measured, and the result is shown in Table 2.

### EXAMPLE 8

Example 8 was performed the same as Example 6 with the exception of substitution of 0.14 wt % acetic acid with 0.1 wt % lithium chloride to prepare the electrospinning composition. The obtained polystyrene nanofiber was identified by scanning electron microscopy (SEM) as shown in FIG. 10. The average diameter thereof was then further measured, and the result is shown in Table 2.

TABLE 2
average diameter of polystyrene nanofiber

| | Average diameter (nm) |
|---|---|
| conventional spinning | Nanofiber not obtained |
| Comparative Example 2 | 250 |
| Example 6 | 160 |
| Example 7 | 165 |
| Example 8 | 104 |

### COMPARATIVE EXAMPLE 3

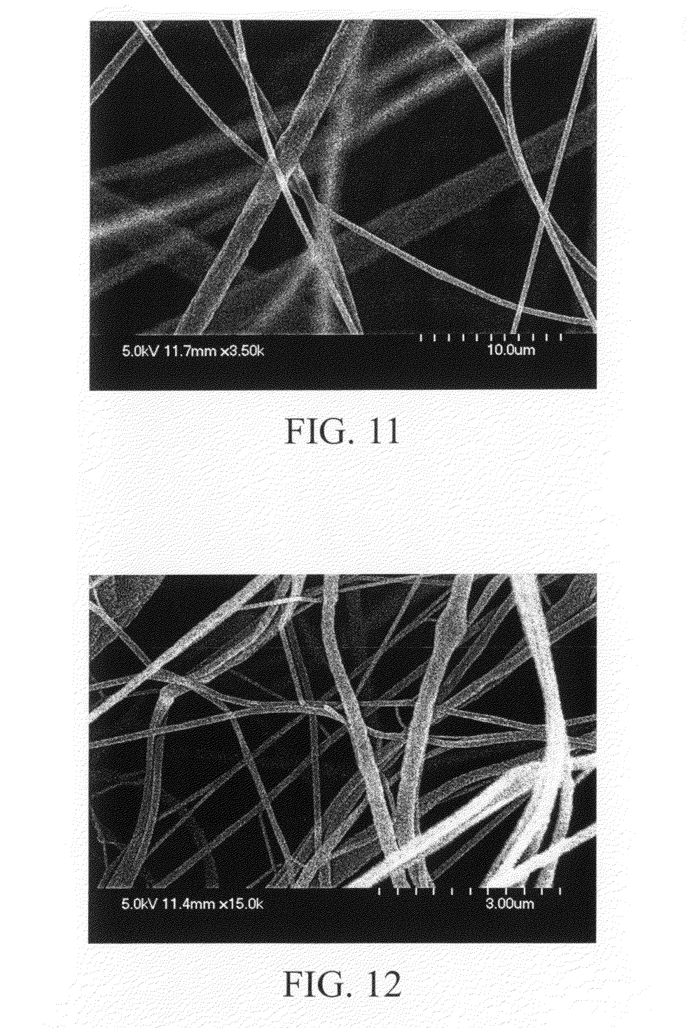

Polycarbonate pellet (molecular weight: 26000 g/mol) was dissolved in chloroform to prepare a solution with 10 wt % polycarbonate. The polycarbonate solution was loaded into a spinneret. The applied voltage of the electrospinning process was 40 KV, the diameter of the nozzle 0.4 mm, the distance between the nozzle to the receiving plate 20 cm, and the feed rate of the polycarbonate solution 15 μl/min. The deposit was cut and polystyrene nanofibers obtained at the receiving plate. The polystyrene nanofiber was identified by scanning electron microscopy (SEM) as shown in FIG. 11. The average diameter thereof was then further measured, and the result is shown in Table 3.

### EXAMPLE 9

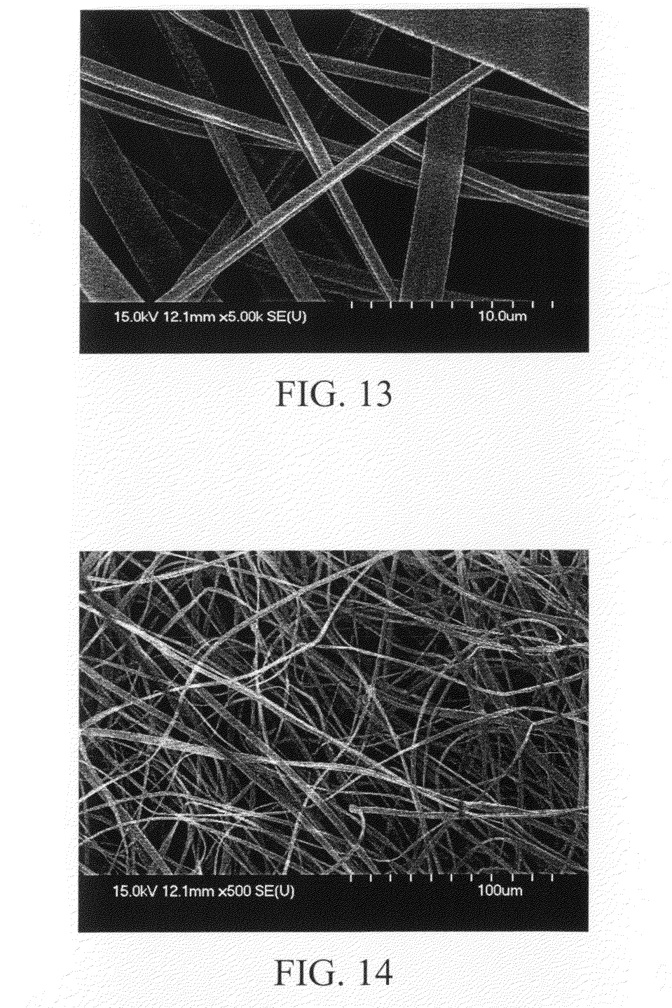

Polycarbonate pellet (molecular weight: 26000 g/mol) was dissolved in chloroform to prepare a solution with 10 wt % polycarbonate. Pyridine was added into the above solution to prepare an electrospinning composition, wherein the pyridine was present in an amount of 0.2 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the feed rate of the electrospinning composition 15 μl/min. The deposit was cut and polycarbonate nanofiber obtained at the receiving plate. The polycarbonate nanofiber was identified by scanning electron microscopy (SEM) as shown in FIG. 12. The average diameter thereof was then further measured, and the result is shown in Table 3.

### EXAMPLE 10

Example 10 was performed the same as Example 9 with the exception of substitution of 0.2 wt % pyridine with 2.0 wt % dimethylacetamide to prepare the electrospinning composition. The obtained polycarbonate nanofiber was identified by scanning electron microscopy (SEM) as shown in FIG. 13. The average diameter thereof was then further measured, and the result is shown in Table 3.

### EXAMPLE 11

Example 11 was performed the same as Example 9 with the exception of substitution of 0.2 wt % pyridine with 2.0 wt % dimethylacetamide and 0.4 % lithium chloride to prepare the electrospinning composition. The obtained polycarbonate nanofiber was identified by scanning electron microscopy (SEM) as shown in FIG. 14. The average diameter thereof was then further measured, and the result is shown in Table 3.

### EXAMPLE 12

Example 12 was performed the same as Example 9 with the exception of substitution of 0.2 wt % pyridine with 4.0 wt % dimethylacetamide and 0.4 % lithium chloride to prepare the electrospinning composition. The obtained polycarbonate nanofiber was identified by scanning electron microscopy (SEM) as shown in FIG. 15. The average diameter thereof was then further measured, and the result is shown in Table 3.

TABLE 3
average diameter of polycarbonate nanofiber

| | Average diameter (nm) |
|---|---|
| conventional spinning | Nanofiber not obtained |
| Comparative Example 3 | 1500 |
| Example 9 | 300 |
| Example 10 | 330 |
| Example 11 | 480 |
| Example 12 | 550 |

### COMPARATIVE EXAMPLE 4

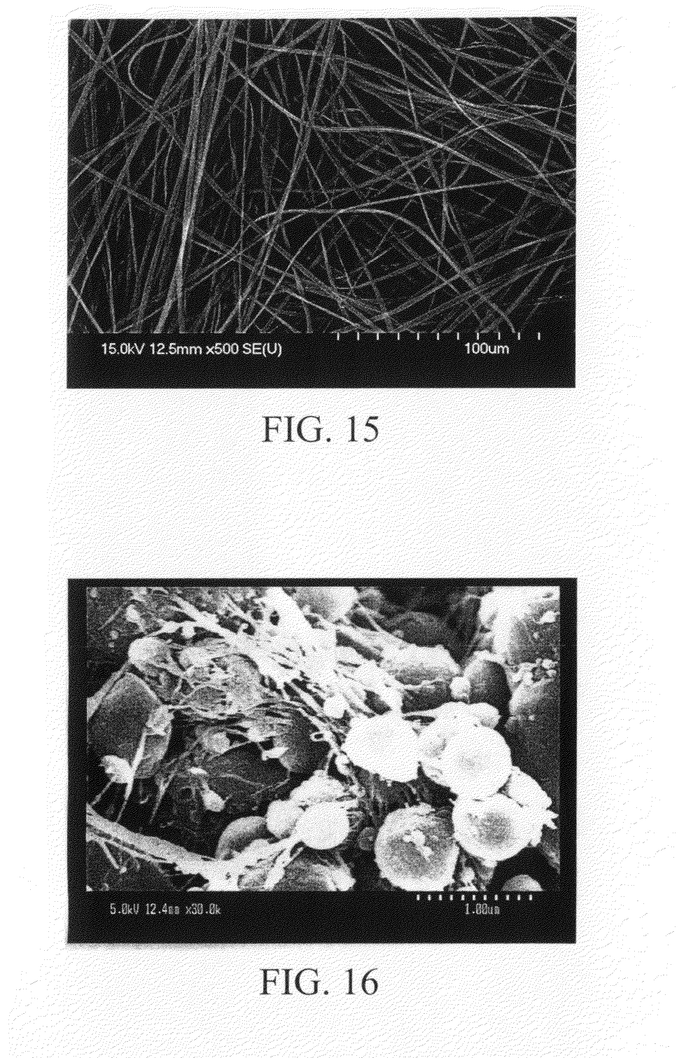

Polyvinylidene fluoride pellet (molecular weight: 64000 g/mol) was dissolved in dimethylacetamide to prepare a solution with 10 wt % polycarbonate. The polyvinylidene fluoride solution was loaded into a spinneret to perform an electrospinning process. The applied voltage of the electrospinning process was 40 KV, the diameter of the nozzle 0.4 mm, the distance between the nozzle to the receiving plate 20 cm, and the feed rate of the polyvinylidene fluoride solution 15 μl/min. The deposit was cut and polyvinylidene fluoride nanofibers obtained at the receiving plate. The polyvinylidene fluoride nanofiber was identified by scanning electron microscopy (SEM) as shown in FIG. 16. The average diameter thereof was then further measured, and the result is shown in Table 4.

### EXAMPLE 13

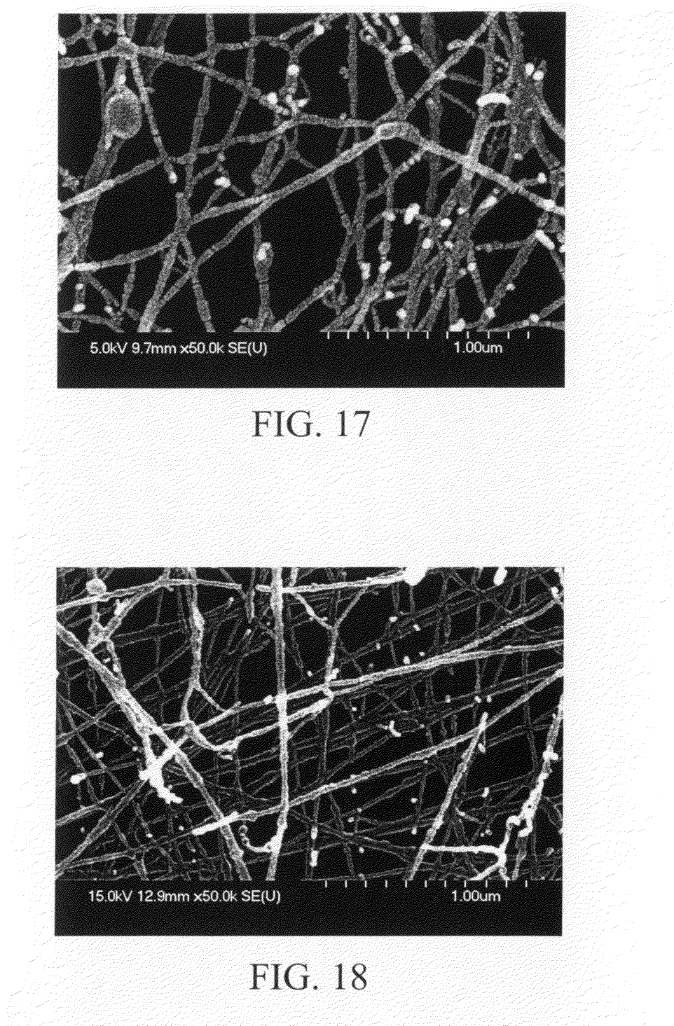

Polyvinylidene fluoride pellet (molecular weight: 64000 g/mol) was dissolved in dimethylacetamide to prepare a solution with 10 wt % polycarbonate. Lithium chloride was added into the above solution to prepare an electrospinning composition, wherein the lithium chloride was present in an amount of 0.5 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the supply rate of the electrospinning composition 15 μl/min. The deposit was cut and polyvinylidene fluoride nanofibers obtained at the receiving plate. The polyvinylidene fluoride nanofiber was identified by scanning electron microscopy (SEM) as shown in FIG. 17. The average diameter thereof was then further measured, and the result is shown in Table 4.

### EXAMPLE 14

Example 14 was performed the same as Example 13 with the exception of substitution of 0.5 wt % lithium chloride with 0.5 wt % lithium chloride and 0.14 wt % acetic acid to prepare the electrospinning composition. The obtained polyvinylidene fluoride nanofiber was identified by scanning electron microscopy (SEM) as shown in FIG. 18. The average diameter thereof was then further measured, and the result is shown in Table 4.

### EXAMPLE 15

Example 15 was performed the same as Example 13 with the exception of substitution of 0.5 wt % lithium chloride with 0.5 wt % lithium chloride and 0.2 wt % pyridine to prepare the electrospinning composition. The obtained polyvinylidene fluoride nanofiber was identified by scanning electron microscopy (SEM) as shown in FIG. 19. The average diameter thereof was then further measured, and the result is shown in Table 4.

TABLE 4
average diameter of polyvinylidene fluoride nanofiber

| | Average diameter (nm) |
|---|---|
| Conventional spinning | Nanofiber not obtained |
| Comparative Example 4 | 1500 |
| Example 13 | 300 |
| Example 14 | 330 |
| Example 15 | 480 |

### COMPARATIVE EXAMPLE 5

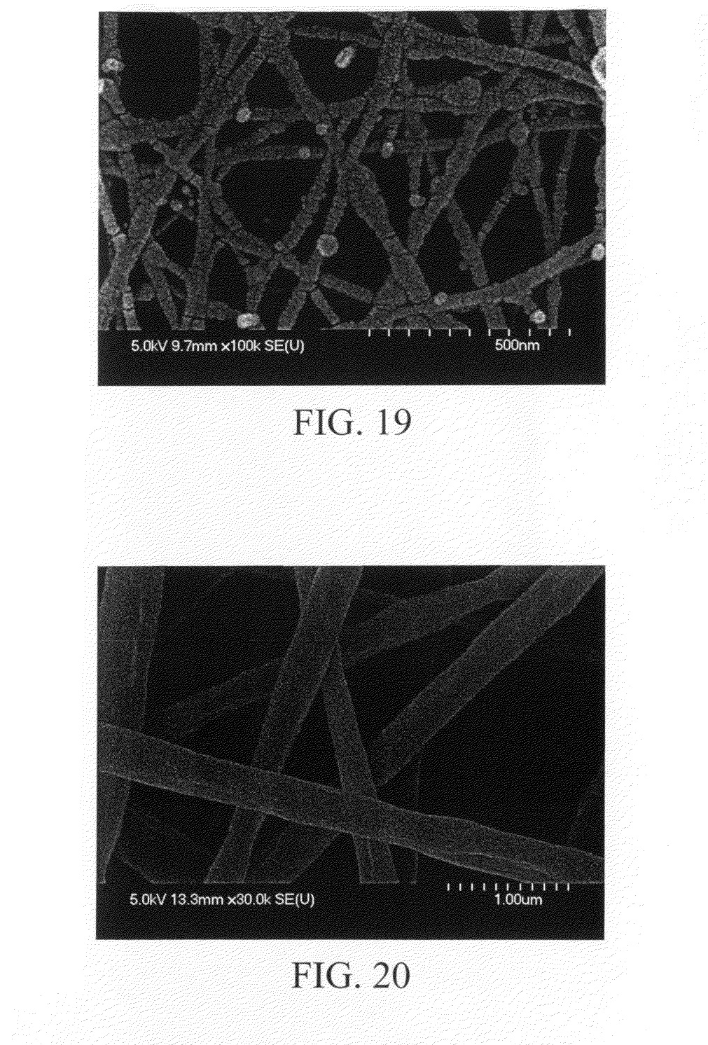

Polyvinylidene fluoride hexafluoropropylene copolymer powder (molecular weight: 64000 g/mol) was dissolved in acetone to prepare a solution with 10 wt % polyvinylidene fluoride hexafluoropropylene copolymer. Polyvinylidene fluoride hexafluoropropylene solution was loaded into a spinneret. The applied voltage of the electrospinning process was 40 KV, the diameter of the nozzle 0.4 mm, the distance between the nozzle to the receiving plate 20 cm, and the feed rate of the polyvinylidene fluoride hexafluoropropylene solution 15 μl/min. The deposit was cut and polyvinylidene fluoride-hexafluoropropylene nanofibers obtained at the receiving plate. The polyvinylidene fluoride hexafluoropropylene nanofiber was identified by scanning electron microscopy (SEM) as shown in FIGS. 20. The average diameter thereof was then further measured, and the result is shown in Table 5.

### EXAMPLE 16

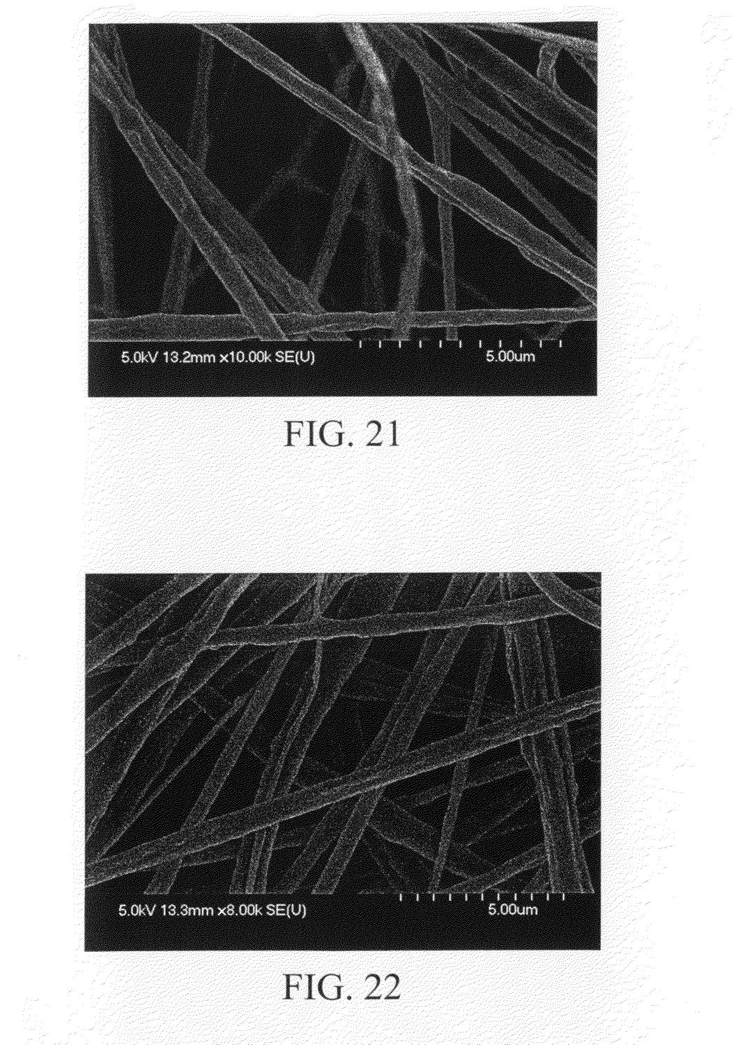

Polyvinylidene fluoride hexafluoropropylene copolymer powder (molecular weight: 64000 g/mol) was dissolved in acetone to prepare a solution with 10 wt % polyvinylidene fluoride hexafluoropropylene copolymer. Acetic acid, serving as additive, was added into the above solution to prepare an electrospinning composition, wherein the acetic acid was present in an amount of 0.14 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the supply rate of the electrospinning composition 15 μl/min. The deposit was cut and polyvinylidene fluoride hexafluoropropylene nanofibers obtained at the receiving plate. The polyvinylidene fluoride hexafluoropropylene nanofiber was identified by scanning electron microscopy (SEM) as shown in FIG. 21. The average diameter thereof was then further measured, and the result is shown in Table 5.

### EXAMPLE 17

Example 17 was performed the same as Example 13 with the exception of substitution of 0.14 wt % pyridine with 0.14 wt % acetic acid to prepare the electrospinning composition. The obtained polyvinylidene fluoride hexafluoropropylene nanofiber was identified by scanning electron microscopy (SEM) as shown in FIG. 22. The average diameter thereof is then further measured, and the result was shown in Table 5.

### COMPARATIVE EXAMPLE 6

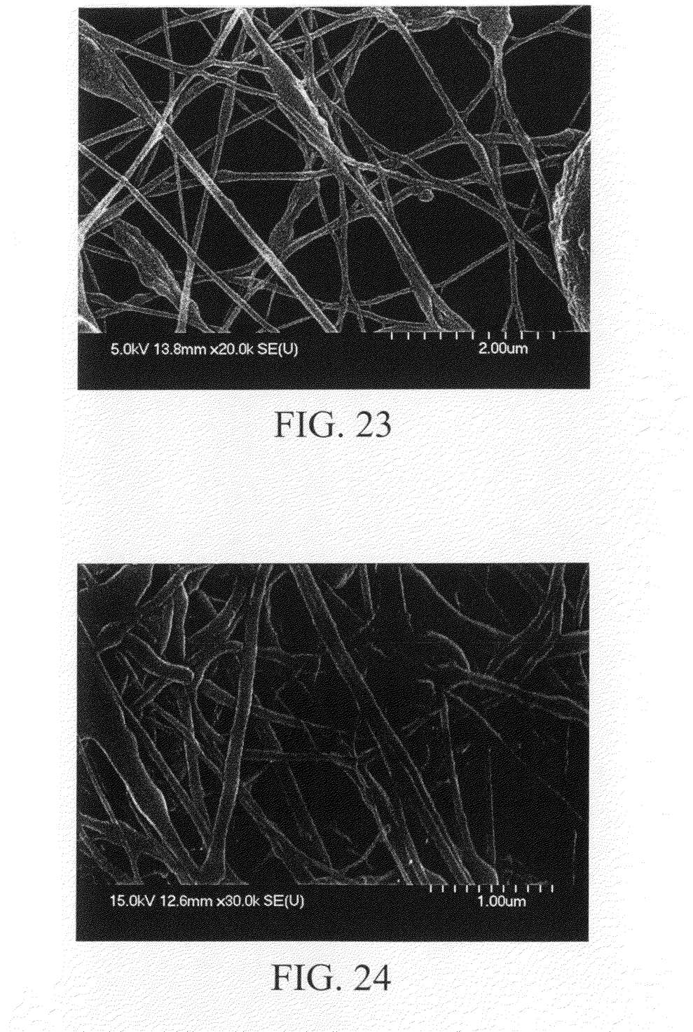

Comparative Example 6 was performed the same as comparative Example 5 with the exception of substitution of dimethylacetamide for acetone as solvent. The obtained polyvinylidene fluoride hexafluoropropylene nanofiber was identified by scanning electron microscopy (SEM) as shown in FIG. 23. The average diameter thereof was then further measured, and the result is shown in Table 5.

### EXAMPLE 18

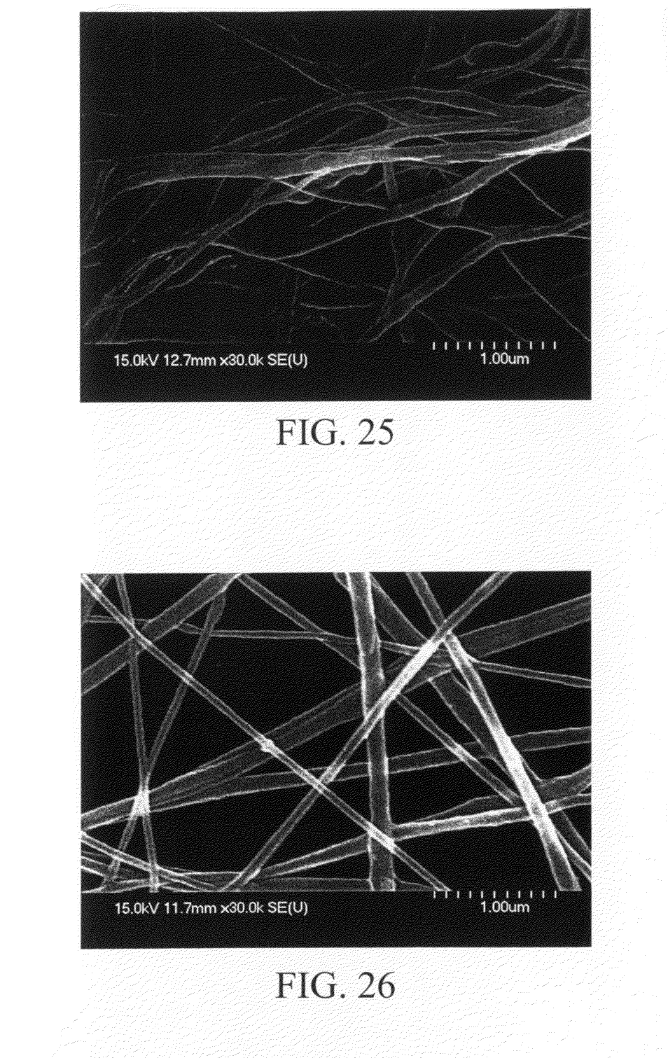

Polyvinylidene fluoride hexafluoropropylene copolymer powder (molecular weight: 64000 g/mol) was dissolved in dimethylacetamide to prepare a solution with 10 wt % polyvinylidene fluoride hexafluoropropylene copolymer. Acetic acid was added into the above solution to prepare an electrospinning composition, wherein the acetic acid was presence in an amount of 0.14 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the feed rate of the electrospinning composition 15 μl/min. The deposit was cut and polyvinylidene fluoride hexafluoropropylene nanofibers obtained at the receiving plate. The polyvinylidene fluoride hexafluoropropylene nanofiber was identified by scanning electron microscopy (SEM) as shown in FIG. 24. The average diameter thereof was then further measured, and the result is shown in Table 5.

### EXAMPLE 19

Example 19 was performed the same as Example 18 with the exception of substitution of 0.20 wt % pyridine with 0.14 wt % acetic acid to prepare the electrospinning composition. The obtained polyvinylidene fluoride hexafluoropropylene nanofiber was identified by scanning electron microscopy (SEM) as shown in FIG. 25. The average diameter thereof was then further measured, and the result is shown in Table 5.

### EXAMPLE 20

Example 20 was performed the same as Example 18 with the exception of substitution of 0.5 wt % lithium chloride with 0.14 wt % acetic acid to prepare the electrospinning composition. The obtained polyvinylidene fluoride hexafluoropropylene nanofiber was identified by scanning electron microscopy (SEM) as shown in FIG. 26. The average diameter thereof was then further measured, and the result is shown in Table 5.

TABLE 5
average diameter of polyvinylidene fluoride
hexafluoropropylene nanofiber.

| | Average diameter (nm) |
|---|---|
| Conventional spinning | Nanofiber not obtained |
| Comparative Example 5 | 550 |
| Example 16 | 350 |
| Example 17 | 400 |
| Comparative Example 6 | 80 |
| Example 18 | 54 |
| Example 19 | 60 |
| Example 20 | 33 |

### EXAMPLE 21

Collagen freeze-dried powder (extracted from animal and dried) was dissolved in water at 25° C. to prepare a solution with 3 wt % collagen. Hydrogen chloride was added into the above solution to prepare an electrospinning composition, wherein the hydrogen chloride was presence in an amount of 0.05 wt % of the electrospinning composition. After mixing completely, the electrospinning composition was loaded into a spinneret. The applied voltage of the electrospinning process was 40 KV, the diameter of the nozzle 0.4 mm, the distance between the nozzle to the receiving plate 20 cm, and the feed rate of the electrospinning composition 15 μl/min. The deposit was cut and collagen nanofibers obtained at the receiving plate. The average diameter of the collagen nanofiber is 100 nm.

Use of the additives disclosed the polymer suitable for use in the electrospinning composition is not limited, and includes the polymers not suitable for conventional electrospinning such as biopolymer. The same solvent and polymer components generate nanofiber, fabricated from electrospinning composition in the absence of the additive as disclosed, with average diameter of 300˜1500 nm (referring to Comparative Examples 1˜6), and the nanofiber fabricated from electrospinning composition in the presence of the additive as disclosed has an average diameter of 50˜500 nm (referring to Examples 1˜20). Accordingly, the nanofiber of the invention is 60%˜85% thinner than that obtained by conventional electrospinning. Moreover, since the electrospinning process of the invention utilizes conventional electrospinning spinnerets and is performed with unlimited supply rate and concentration of electrospinning composition, the invention readily provides at high throughput and yield compared with conventional electrospinning.

While the invention has been described by way of example and in terms of preferred embodiment, it is to be understood that the invention is not limited thereto. It is therefore intended that the following claims be interpreted as covering all such alteration and modifications as fall within the true spirit and scope of the invention.

What is claimed is:

1. A method for fabricating nanofiber, comprising: providing an electrospinning composition; and subjecting the electrospinning composition to an electrospinning process, wherein the electrospinning composition comprises a polymer and an additive as a uniform solution in an organic solvent, and the additive renders the electronic characteristic of the polymer.

2. The method as claimed in claim 1, wherein polymer comprises water-soluble polymer, oil-soluble polymer, biopolymer or combination thereof.

3. The method as claimed in claim 1, the polymer comprises polyethylene, polyvinyl alcohol, sodium alginate, gelatin, collagen, polystyrene, polycarbonate, chitosan, fluorine polymer, polyester, polyamide, polyimide, or combination thereof.

4. The method as claimed in claim 1, wherein the additive is present in an amount of 0.01 wt % to 15 wt %, based on the weight of the electrospinning composition.

5. The method as claimed in claim 1, wherein the additive comprises organic or inorganic salt, organic or inorganic acid, organic or inorganic base, polar compound, or combination thereof.

6. The method as claimed in claim 5, wherein the organic or inorganic salt comprises fluorine salt, chlorine salt, bromine salt, iodine salt, sulfate salt, nitrate salt, carboxylate salt, oxalate salt, borate salt, sulfonate salt, perchlorate salt, citrate salt, or combination thereof.

7. The method as claimed in claim 5, wherein the organic or inorganic salt comprises lithium salt, sodium salt, potassium salt, beryllium salt, calcium salt, aluminum salt, magnesium salt, titanium salt, or combination thereof.

8. The method as claimed in claim 5, wherein the organic acid, inorganic acid, organic base, or inorganic base is monoacid, polyacid, monobase, or polybase, comprising C1-18 carboxylic acid, C1-18 alcohol, ammonia, imidazole, metal hydroxyl compound, hydrochloric acid, nitric acid, boric acid, perchloric acid, sulfuric acid, phosphoric acid, lactic acid, benzoic acid, or citric acid.

9. The method as claimed in claim 5, wherein the polar compound comprises pyridine, formamide, dimethylformamide, N-dimethylacetamide, N-methylpyrrolidone, valerolactam, caprolactam, o-dichlorobenzene, tetramethylurea, acetonitrile, or combination thereof.

10. The method as claimed in claim 1, wherein the nanofiber has an average diameter of 15˜500 nm.

11. The method as claimed in claim 1, wherein the electrospinning process has an applied voltage of 20˜50 KV.

12. The method as claimed in claim 1, wherein the electrospinning process employs a spinneret with a distance between a nozzle and a receiving plate of 10˜30 cm.

13. The method as claimed in claim 1, wherein the additive is an electrolyte.
